(19) United States
(12) Patent Application Publication
(10) Pub. No.: US 2004/0177716 A1
(43) Pub. Date: Sep. 16, 2004

(54) Foot-adjusting handgrip

(76) Inventor: Heng-Chun Ku, Ping-Chen City (TW)

Correspondence Address: SUPREME PATENT SERVICES, POST OFFICE BOX 2339, SARATOGA, CA, 95070, US

(21) Appl. No.: 10/389,726

(22) Filed: Mar. 13, 2003

(51) Int. Cl. G05G 1/10

(52) U.S. Cl. 74/543

(57) ABSTRACT

A foot-adjusting handgrip comprises a retaining ring, a lever member, a slide-block member, and a handgrip, in which the retaining ring further comprises a gap, a serrate formation, and a base; the lever member comprises a fixing lever and a sleeve-lever locked at the front and the rear edge of the gap respectively; the slide-block member is comprised of an operating arm, a slide block, and a fixing block; the handgrip includes an upper and a lower lid. The slide block will move backwards as soon as the operating arm is lifted, and a pin defined in the top end of the fixing block will choke the slide block at its front edge to cause the retaining ring to get pinched. If a releasing state of the retaining ring is desired, a user is supposed to push a pushbutton forwards so that a slope in a slide piece will conflict the pin and move the slide block forwards to loosen the retaining ring.

### BACKGROUND OF THE INVENTION

1. Field of the Invention

This invention relates to a foot-adjusting handgrip, and it relates more specifically to an adjustment structure, which is capable of regulating the position of a carrying platform of a supporting foot rapidly and stably.

2. Description of the Prior Arts

A conventional foot-adjusting handgrip is generally comprised of a retaining ring and a rod member, in which the retaining ring for clenching a horizontal shaft of foot has a gap, a through hole penetrating the gap transversely, a base for fixing a carrying platform; and the front end of the rod member is threaded. The threaded front end is sleeve-jointed to the hole by locking with a nut at an outer side of a front verge of the gap in the retaining ring while the rear end behind the thread portion would prop with a gasket against an outer side of a rear verge of the gap, such that the distance between the nut and the gasket is adjustable by turning the rod member for controlling closing or opening of the gap and hence tightness of the retaining ring accordingly.

Unfortunately, the carrying platform is liable to be displaced when turning the rod, and this is the point calling for improvements as disclosed in the present invention.

### SUMMARY OF THE INVENTION

The primary object of this invention is to provide a foot-adjusting handgrip for regulating the position and orientation of a carrying platform rapidly and stably. The foot-adjusting handgrip mainly comprises a retaining ring, a lever member, a slide-block member, and a handgrip, in which the retaining ring further comprises a gap, a serrate formation in its inner side for retaining a foot's horizontal shaft, and a base located thereon for anchoring a carrying platform; the lever member further comprises a fixing lever and a sleeve-lever locked at the front and the rear edge of the gap respectively, in which a spring is disposed between the fixing lever and the sleeve-lever for packing the gap of the retaining ring closely; the slide-block member is comprised of an operating arm, a slide block, and a fixing block, in which an upward recess is arranged at the tail end of the operating arm and a tooth formation is arranged on each upper edge of side walls of the recess; the slide block has a tooth bar formed on each of two sides of its lower edge; and the fixing block is provided with a downwardly directed recess for receiving the slide block. The end portion behind the recess of the fixing block is substantially an opening allowing the fixing lever to go through back and forth for releasing or pinching the retaining ring when the operating arm is moved to drive the slide block. Besides, a flanged circular hole is arranged in the fixing block above the recess for receiving a pin to thereby constrain movement of the slide block. The handgrip includes an upper and a lower lid, in which the lower lid has an opening for the operating arm to penetrate while the upper lid has an inside reed leaf and an opening for accommodating a pushbutton, in which the reed leaf is used for depressing the pin to rest in a circular hole on the fixing block. The pushbutton has a lower projecting portion with a horizontal hole hitched on the sleeve-lever to thereby enable the pushbutton to be moved back and forth along the sleeve-lever. Also, the pushbutton is connected with a slide piece having a slope and a tetragonal hole, in which the slope is capable of releasing the choking state of the slide block made by the pin. Therefore, the slide block will move backwards as soon as the operating arm is lifted, and the pin will choke the slide block at its front edge to cause the retaining ring to get pinched. If, on the contrary, a releasing state of the retaining ring is desired, a user is supposed to push the pushbutton forwards so that the slope of the slide piece will conflict the pin and move the slide block forwards to loosen the retaining ring as expected.

In short, a user might use this simple way for regulating the carrying platform by first pushing the pushbutton forwards to release the retaining ring, then adjusting the platform, and finally lifting the operating arm to have the retaining ring pinched tightly.

For more detailed information regarding advantages or features of this invention, at least an example of preferred embodiment will be described below with reference to the annexed drawings.

### BRIEF DESCRIPTION OF THE DRAWINGS

The related drawings in connection with the detailed description of this invention to be made later are described briefly as follows, in which:

FIG. 1 is a structural view of a foot-adjusting handgrip of this invention in three-dimensions;

FIG. 1 is an exploded view of the foot-adjusting handgrip of this invention;

FIG. 3 shows a cutaway section of the foot-adjusting handgrip of this invention under a released state;

FIG. 4 shows a cutaway section of the foot-adjusting handgrip of this invention under an intense state;

FIG. 5 is a cutaway sectional view showing the foot-adjusting handgrip of this invention under a releasing procedure;

FIG. 6 shows a schematic cutaway section of a slide block and pin under a released state of the foot-adjusting handgrip of this invention; and

FIG. 7 shows a schematic cutaway section of the slide block and pin under an intense state of the foot-adjusting handgrip of this invention.

### DETAILED DESCRIPTION OF THE PREFERRED EMBODIMENT

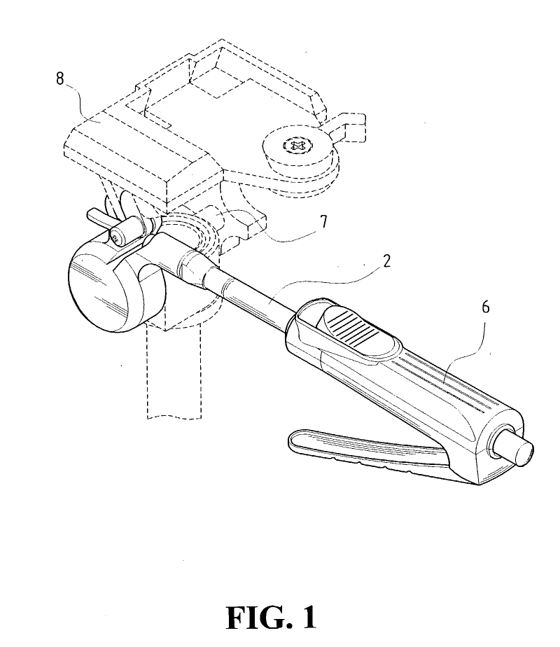

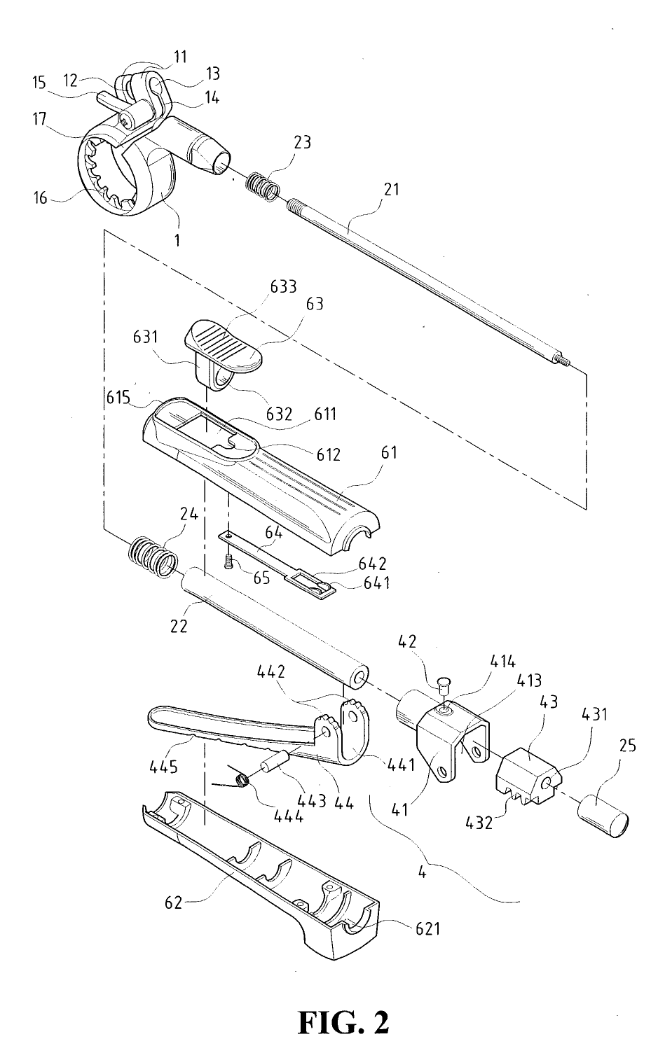

As shown in FIGS. 1 and 2, a foot-adjusting handgrip of this invention is comprised of a retaining ring 1, a lever member 2, a slide-block member 4, and a handgrip 6.

The retaining ring 1 further comprises a gap 17, an inside serrate formation 16 for retaining a foot's horizontal shaft 7, and a base 11 located thereon for anchoring a platform 8. There are two circular holes 12/13 in the base 11 arranged for setting the platform, in which a slit 14 is formed communicable with the circular hole 13, and the slit 14 is locked tightly with a stud 15 for fixing the platform 8. The lever member 2 further comprises a fixing lever 21 and a sleeve-lever 22 locked at the front and the rear edge of the gap 17 respectively, in which a spring 23 is inserted between the fixing lever 21 and the sleeve-lever 22 for packing the gap 17 of the retaining ring 1.

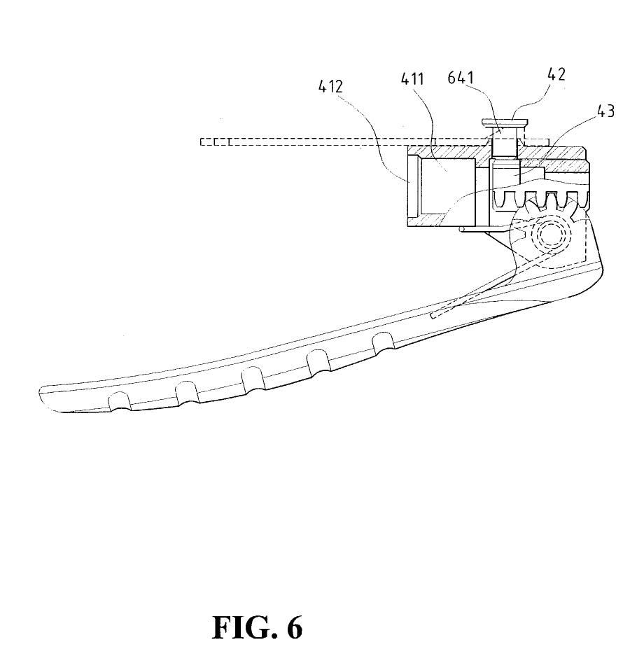

The slide-block member 4 is comprised of an operating arm 44, a slide block 43, and a fixing block 41, in which an anti-slip flute formation 445 is formed on a lower edge of the operating arm 44, an upward recess 441 is arranged at the tail end of the operating arm 44, and a tooth formation 442 is formed on each upper edge of side walls of the recess 441. The slide block 43 has a perforated horizontal through hole 431 and a tooth bar 432 formed on each of two sides of its lower edge. The fixing block 41 is provided with a horizontal hole 411 (shown in FIG. 6) formed at its front end, a flange 412 formed at its front edge for propping against the sleeve-lever 22, and a downwardly directed recess 413 at its tail end for receiving the slide block 43, in which the rear end of the recess 413 is open; a flanged circular hole 414 is arranged in the fixing block 41 above the recess 413 for receiving a pin 42 to thereby choke movement of the slide block 43. When assembling the slide-block member 4, the slide block 43 is placed in the recess 413 at the fixing block's tail end, and the tooth bar 432 of the slide block 43 is engaged with the tooth formation 442 of the operating arm 44 and fixed with a plug 443 as well as a spring 444, such that the whole slide-block member 4 could be sleeve-jointed to the fixing lever 21 and locked with a nut 25.

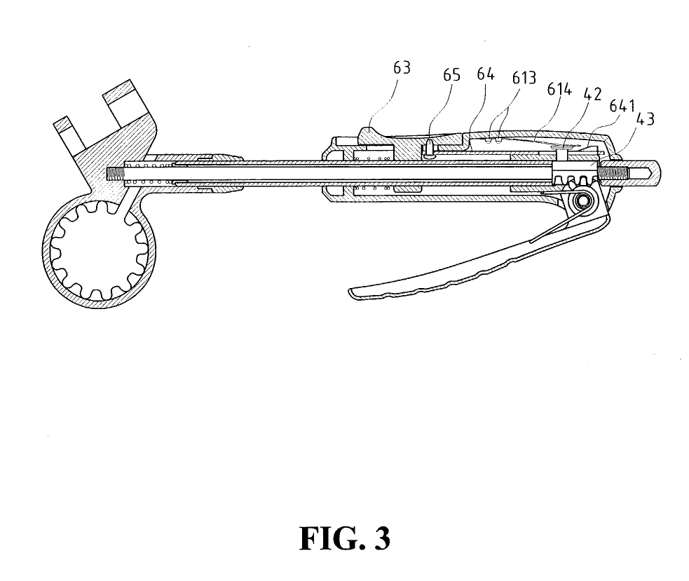

The handgrip 6 includes an upper and a lower lid 61/62, in which the lower lid 62 has an opening 621 allowing the operating arm 44 to penetrate while the upper lid 61 has a protrusion 613 for fixing a reed leaf 614 (shown in FIG. 3) and an opening 611 for accommodating a pushbutton 63, in which a protruding edge 615 is formed on the upper edge of the opening 611 defined in the upper lid for limiting the movement range of the pushbutton 63, in which the protruding edge 615 is so high approximately as the rear end of the pushbutton 63 so that a flush appearance could be ensured after assembling. Moreover, a dent 612 is formed in the rear edge of the opening 611 for a user to push the pushbutton 63 to reach the dent 612 and stay there by taking advantage of elastic force of the spring 24, in which the pushbutton 63 has a higher front end and transverse projecting veins 633 on the surface thereof to make a push easier and a lower projecting portion 631 having a horizontal hole 632 hitched on the sleeve-lever 22 to thereby enable the pushbutton 63 to be moved back and forth along the sleeve-lever 22. A slide piece 64 having a tetragonal hole 642 and a slope 641 is locked to the pushbutton 63 by a bolt 65, in which the width of tetragonal hole 642 must be large enough to permit the pin 42 and the reed leaf 614 to pass through (referring to FIG. 3) such that the reed leaf 614 will tightly depress the pin 42 to stay on the flanged circular hole 414 in the top end of the fixing block 41. In this case, the width of the tetragonal hole 642 must be narrower than the outer diameter of the head of the pin 42 but wider than the outer diameter of the flanged circular hole 414 in favor of pinching the slide piece 64 between the pin's head and the fixing block 41, such that the pin 42 may be lifted up or plugged in the flanged circular hole 414 of the fixing block 41 by moving the slope 641 of the slide piece 64. Herein, the flanged circular hole 414 of the fixing block 41 better be slightly higher than thickness of the slide piece 64 to ensure a smooth slide of the latter.

When a user lifts the operating arm 44, the slide block 43 is driven to move backwards and the pin 42 is supposed to choke the slide block 43 at its front edge. If the user pushes the pushbutton 63 forwards, the slide piece 64 is driven to move forwards accordingly, and the pin 42 is forcibly lifted by the slope 641 of the slide piece 64 to release the choking state of the pin 42 against the front edge of the slide block 43 and allow the latter to move forwards. Now, if the user releases the pushbutton 63, the pushbutton 63 is supposed to avail the elastic force of the spring 24 to return to the dent 612 at the rear edge of the upper lid, and the pin 42 is located on the slide block 43 at this moment.

The interconnection and interaction of the relevant components are described hereafter in detail.

As indicated in FIGS. 3 through 5, as the front end of the fixing lever 21 is fixedly locked at the front edge of the gap 17, and the sleeve-lever 22 and the slide-block member 4 are hitched on the fixing lever 21, which is locked with a nut 25 at its rear end, therefore, a constant distance is maintained between the front end of the gap 17 and the nut 25. Also, because the front end of the sleeve-lever 22 is fixedly locked at the rear edge of the gap 17 and the rear end of the sleeve-lever 22 is propping against the flange 412 of the front edge of the horizontal hole 411 at the front end of the fixing block 41 (shown in FIG. 6), hence, another constant distance between the rear edge of the gap 17 and the fixing block 41 is held. By the foregoing arrangements, the slide block 43 could be driven by the operating arm 44 to in turn drive the fixing lever 21 to move back and forth so as to make the retaining ring 1 released or pinched for regulating the position and orientation of the platform 8.

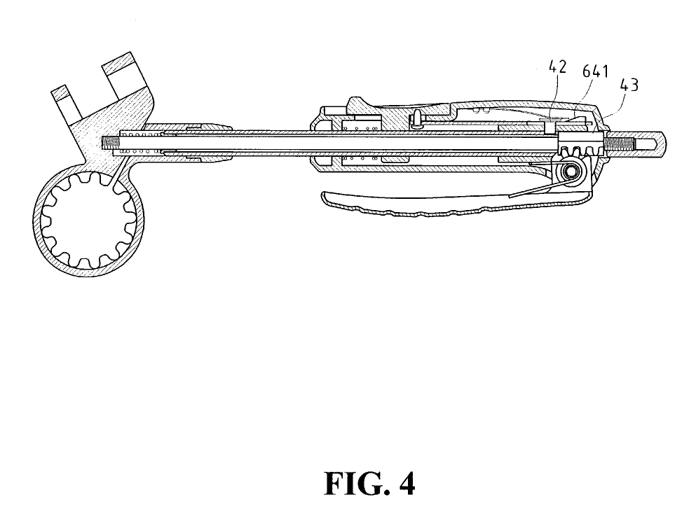

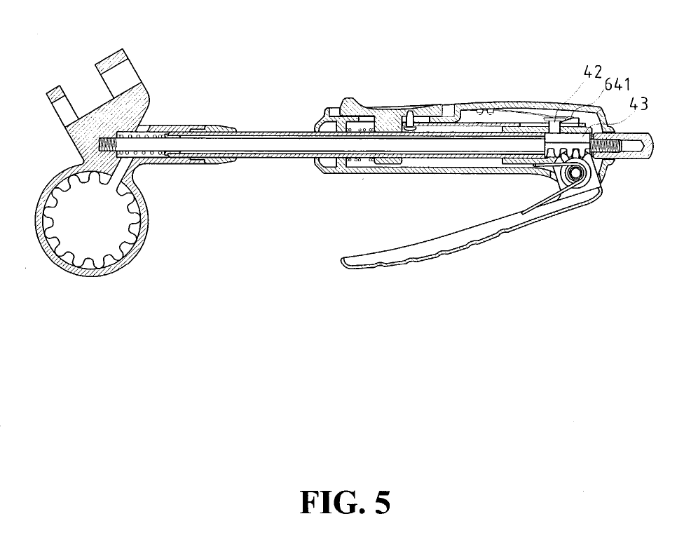

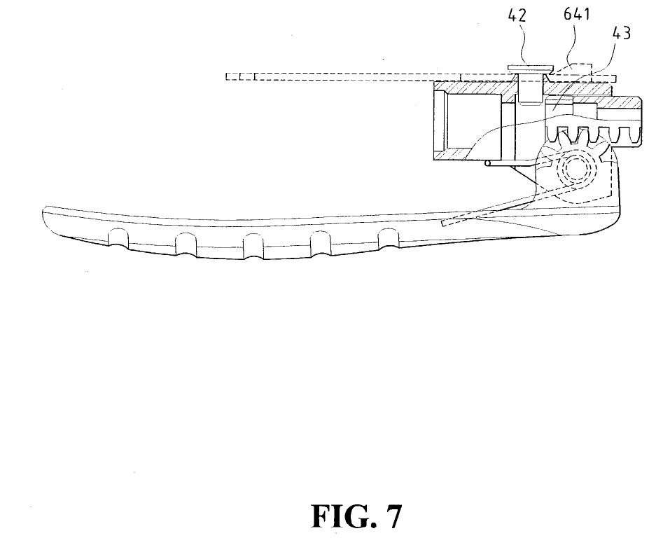

The pin 42 is located on the slide block 43 as shown in FIG. 3. Herein, the retaining ring 1 is situated under a released state. In FIG. 4, the pin 42 will choke the slide block 43 at its front edge when the operating arm 44 is lifted to withdraw the slide block 43. At this moment, the retaining ring 1 is situated under a pinched state. When releasing the pinched state is desired, a user has to lift the operating arm 44 slightly so that the pin 42 will separate from the front edge of the slide block 43 a little bit (shown in FIG. 7), and meanwhile, the user is requested to push the pushbutton 63 forwards so that the slope 641 of the slide piece 64 is enabled to conflict the pin 42 and lift it to allow the slide block 43 to move forwards (shown in FIG. 6). The user is then supposed to release the pushbutton 63 (shown in FIG. 5) such that the pushbutton 63 is pushed back to the dent 612 at the rear edge of the opening of the upper lid by taking advantage of the elastic force of the spring 24. Now, the pin 42 is located on the slide block 43 and the retaining ring 1 is situated under a released state again.

In the above described, at least one preferred embodiment has been described in detail with reference to the drawings annexed, and it is apparent that numerous changes or modifications may be made without departing from the true spirit and scope thereof, as set forth in the claims below.

What is claimed is:

1. A foot-adjusting handgrip, comprising:
a retaining ring having a gap, an inside serrate formation for tightly retaining a foot's horizontal shaft, and a base located on the retaining ring for fixing a carrying platform, in which the base is provided with two circular holes for fixing the platform, in which a slit is formed communicable with one circular hole, and the slit is locked tightly with a stud for fixing the platform;
a lever member comprised of a fixing lever and a sleeve-lever locked at a front and a rear edge of the gap respectively, in which a spring is disposed between the fixing lever and the sleeve-lever for packing the gap of the retaining ring tightly;
a slide-block member including an operating arm, a slide block, and a fixing block, in which an anti-slip flute formation is formed on a lower edge of the operating arm; an upward recess is arranged at the tail end of the operating arm and a tooth formation is arranged on each upper edge of side walls of the recess; the slide block has a tooth bar formed on each of two sides of its lower edge for engaging with the tooth formation; and the fixing block is provided with a downwardly directed recess for receiving the slide block; the end portion behind the recess of the fixing block is substantially an opening allowing the fixing lever to go through back and forth for releasing or pinching the retaining ring by moving the operating arm to drive the slide block; and in addition, a flanged circular hole is defined in the fixing block above the recess for receiving a pin to thereby choke the movement of the slide block; and
a handgrip including an upper and a lower lid, in which the lower lid has an opening allowing the operating arm to penetrate while the upper lid has a protrusion for fixing a reed leaf and an opening for accommodating a pushbutton, in which the reed leaf is used for depressing the pin; a projecting portion provided to the pushbutton has a horizontal hole hitched on the sleeve-lever, such that the pushbutton could be moved back and forth along the sleeve-lever, and the pushbutton is also connected with a slide piece having a slope and a tetragonal hole, in which the slope is capable of releasing the choking state of the slide block made by the pin.

2. The handgrip according to claim 1, in which the height of the flanged circular hole in the fixing block must be slightly thicker than the thickness of the slide piece for ensuring a smooth slide motion of the slide piece.

3. The handgrip according to claim 1, in which the width of the tetragonal hole defined in the slide piece must be wide enough for the pin and the reed leaf to pass through and for the reed leaf to depress the pin in the circular hole on the fixing block, and must be narrower than the diameter of the head of the pin and larger than the outer diameter of the flanged circular hole in the top end of the fixing block to hence position the slide piece between the head of the pin and the fixing block so as to allow the slope of the slide piece to move and conflict to lift the pin or plug the pin in the flanged circular hole of the fixing block.

4. The handgrip according to claim 1, in which the front end of the pushbutton has a comparative height and a lot of transverse projecting veins on the surface thereof in favor of displacement.

5. The handgrip according to claim 1, in which a protruding edge is formed on the upper edge of the opening of the upper lid for limiting the movement range of the pushbutton, in which the protruding edge is so high approximately as the rear end of the pushbutton so that a smooth and flush appearance could be ensured after assembling.

6. The handgrip according to claim 1, in which a dent is defined at a rear edge of the opening of the upper lid such that the pushbutton could be pushed to reach the dent and stay there by taking advantage of the elastic force of a spring.
